(19) United States
(12) Patent Application Publication
(10) Pub. No.: US 2024/0296402 A1
(43) Pub. Date: Sep. 5, 2024

(54) METHOD, SYSTEM, AND SOFTWARE FOR TRACING PATHS IN GRAPH

(71) Applicant: Hitachi, Ltd., Tokyo (JP)

(72) Inventor: Qi XIU, Mountain View, CA (US)

(21) Appl. No.: 18/110,211

(22) Filed: Feb. 15, 2023

(51) Int. Cl. G06Q 10/0633; G06F 16/901; G06F 16/906; G06Q 50/00

(52) U.S. Cl. CPC G06Q 10/0633; G06F 16/9024; G06F 16/906; G06Q 50/01

(57) ABSTRACT

Trace flow of nodes in a graph structure dataset through meta-paths. For an input of a graph structure dataset, systems and methods can involve defining types and attributes for the plurality of nodes and the plurality of edges to generate a heterogenous graph from the input graph structure dataset; associating the plurality of nodes with each other based on similarity; defining a scheme for a meta-path between the plurality of nodes and the plurality of edges based on defined flows; sampling positive meta-paths and negative meta-paths for a selected node from the heterogenous graph based on the defined scheme; projecting the associated plurality of nodes into embedded vectors; and tracing paths of associated nodes having a similarity with the starting node specified by user greater than a preset threshold.

### BACKGROUND

### Field

The present disclosure is generally related to data management systems, and more specifically, towards a method, system, and software for tracing paths in a graph.

### Related Art

In graph structured data such as a supply chain, a social network, and a contact network, tracing paths are often of the interest. Such tracing of paths can include tracing the physical flow of a product in a supply chain to mitigate loss after supply chain disruption, tracing information flow of news in social network to specify the source of information or maximize influence, or tracing infection routes of contagious disease to predict and even prevent a pandemic.

FIG. 1 illustrates the example of physical flow in supply chain: a production halt of automobiles caused by a chip-shortage. After the chip shortage, engine shortage and production halt of automobiles, the demand for automobile parts are eventually reduced as a result.

For automobile parts manufacturers, tracing the physical flow of an automobile can help predict demand reduction in advance and mitigate loss. Similarly, tracing the cashflow in a supply chain can help financial institutions predict possible needs for operation funds and provide financial services timely.

However, in graph structure data, there normally exist multiple paths among a plurality of entities, each entity input and output objects. Moreover, the correspondence between the input and output objects are normally unknown. For instance, in a supply chain, each company produces different products. The correlation between the input (raw materials and parts) and output (products) are normally confidential. Thus, as illustrated in FIG. 2, the physical flow of each product can hardly be traced, making it challenging to replace a component company when supply chain disruptions are encountered.

In a social network illustrated in FIG. 3, tracing the path of fake news propagation can help social media platforms keep the users away from fake information. However, in a social network, each user has multiple incoming and outgoing interactions with other users, such as reading multiple post from other users, and posting multiple messages to other users. The correlation between the incoming and outgoing posts are unknown, making it challenging to trace the path of fake news propagation.

There have been many related art implementations proposed to trace the paths in a graph structured data. For the supply chain, an agent-based model where agents such as suppliers and buyers, follow specified rules are used to model propagation of negative shocks. However, in the model, each firm in a sector is hypothesized to produces only one sector-specific product, which is not always true. For instance, there can be a company that produces multiple types of products, including lithium battery, refrigerator, and so on, which cannot be modeled by the related art implementations.

In the domain of social network, the related art focuses on tracing the fake news propagation path in social network. The users posted fake news is firstly detected and classified, then their neighbors are traced iteratively to learn the propagation path. However, such related art implementations assume that users post fake news because of incoming messages, which is not true. In the real world, the user normally receives multiple incoming interactions, mixed with actual news and fake news. The outgoing post of fake news is only caused by parts of incoming interactions.

Thus, the related art methods either rely on the willingness of information sharing between entities or are not able to be commonly applied. Some related art implementations propose to trace the physical flow in a supply chain by sending questionnaires to related firms, using intermediaries who perform supply chain surveillance. In other related art implementations, electronic data interchange (EDI) messages and tracking technology including Radio Frequency identifiers (RFIDs) are used, respectively. In an example related art implementation, bill-of-material (BOM) with relationships between assemblies, sub-assemblies (defined as components here) and final products are utilized to as the correlation between input and output for tracing paths in a graph structured data.

### SUMMARY

Example implementations described herein involve a method, system, and software for tracing paths in graph structured data. Such tracing of paths can involve tracing the physical flow or cashflow of each product in a supply chain, or tracing the propagation path of fake news in a social network. However, in these graph structured graphs, there exist multiple interactions between entities. For example, in a supply chain, each company produces multiple types of product, using a variety of intermediates and materials. In a social network, each user receives and send multiple posts. Furthermore, the correlation between the incoming and outgoing interactions (material and product, incoming and outgoing post) is unknown. Tracing paths in such graph structured data is the problem to be addressed by the example implementations described herein.

Aspects of the present disclosure can involve a method to trace flow of a node in a graph structure dataset through meta-paths, which can involve, for an input of a graph structure dataset comprising a plurality of nodes and a plurality of edges, each of the plurality of nodes representative of an object, each of the plurality of edges representative of an interaction between each of the plurality of nodes; defining types and attributes for the plurality of nodes and the plurality of edges to generate a heterogenous graph from the input graph structure dataset; associating the plurality of nodes with each other based on similarity; defining a scheme for a meta-path between the plurality of nodes and the plurality of edges based on defined flows; sampling positive meta-paths and negative meta-paths for a selected node from the heterogenous graph based on the defined scheme, the associated plurality of nodes and the defined types and attributes for the associated plurality of nodes; projecting the associated plurality of nodes into embedded vectors; from the starting node specified by user, tracing paths of associated nodes having a similarity with the starting node greater than a preset threshold; and outputting the selected ones of nodes as traced paths through an interface. In example implementations described herein, the heterogeneous graph involves a graph which contains multiple types of nodes and edges.

Aspects of the present disclosure can involve a computer program to trace flow of a node in a graph structure dataset through meta-paths, which can involve instructions including, for an input of a graph structure dataset comprising a plurality of nodes and a plurality of edges, each of the plurality of nodes representative of an object, each of the plurality of edges representative of an interaction between each of the plurality of nodes; defining types and attributes for the plurality of nodes and the plurality of edges to generate a heterogenous graph from the input graph structure dataset; associating the plurality of nodes with each other based on similarity; defining a scheme for a meta-path between the plurality of nodes and the plurality of edges based on defined flows; sampling positive meta-paths and negative meta-paths for a selected node from the heterogenous graph based on the defined scheme, the associated plurality of nodes and the defined types and attributes for the associated plurality of nodes; projecting the associated plurality of nodes into embedded vectors; from the starting node specified by user, tracing paths of associated nodes having a similarity with the starting node greater than a preset threshold; and outputting the selected ones of nodes as traced paths through an interface. The computer program and instructions can be stored on a non-transitory computer readable medium and executed by one or more processors.

Aspects of the present disclosure can involve a system to trace flow of a node in a graph structure dataset through meta-paths, which can involve, for an input of a graph structure dataset comprising a plurality of nodes and a plurality of edges, each of the plurality of nodes representative of an object, each of the plurality of edges representative of an interaction between each of the plurality of nodes; means for defining types and attributes for the plurality of nodes and the plurality of edges to generate a heterogenous graph from the input graph structure dataset; associating the plurality of nodes with each other based on similarity; means for defining a scheme for a meta-path between the plurality of nodes and the plurality of edges based on defined flows; means for sampling positive meta-paths and negative meta-paths for a selected node from the heterogenous graph based on the defined scheme, the associated plurality of nodes and the defined types and attributes for the associated plurality of nodes; means for projecting the associated plurality of nodes into embedded vectors; means for from the starting node specified by user, tracing paths of associated nodes having a similarity with the starting node greater than a preset threshold; and means for outputting the selected ones of nodes as traced paths through an interface.

Aspects of the present disclosure can involve an apparatus to trace flow of a node in a graph structure dataset through meta-paths, which can involve a processor configured to, for an input of a graph structure dataset comprising a plurality of nodes and a plurality of edges, each of the plurality of nodes representative of an object, each of the plurality of edges representative of an interaction between each of the plurality of nodes; define types and attributes for the plurality of nodes and the plurality of edges to generate a heterogenous graph from the input graph structure dataset; associating the plurality of nodes with each other based on similarity; define a scheme for a meta-path between the plurality of nodes and the plurality of edges based on defined flows; sample positive meta-paths and negative meta-paths for a selected node from the heterogenous graph based on the defined scheme, the associated plurality of nodes and the defined types and attributes for the associated plurality of nodes; project the associated plurality of nodes into embedded vectors; trace paths of associated nodes having a similarity with the starting node greater than a preset threshold; and output the selected ones of nodes as traced paths through an interface.

### BRIEF DESCRIPTION OF DRAWINGS

FIG. 1 illustrates an example reduction in the demand of automobile parts caused by a chip shortage in a supply chain.

FIG. 2 illustrates an example tracing of a physical flow by product in supply chain that requires confidential product-parts information.

FIG. 3 illustrates the trace infection routes in contact network.

FIG. 4(A) illustrates the processing flow of paths tracing in heterogeneous graph, in accordance with an example implementation.

FIGS. 4(B) and 4(C) illustrate example inputs for the heterogeneous graph generation server, in accordance with an example implementation.

FIGS. 4(D) and 4(E) illustrate example outputs of the heterogeneous graph generation server, in accordance with an example implementation.

FIG. 5 illustrates the processing flow of heterogeneous graph generation, in accordance with an example implementation.

FIG. 6 illustrates the processing flow of heterogeneous graph attributes generation, in accordance with an example implementation.

FIG. 7 illustrates the heterogeneous graph of supply chain, in accordance with an example implementation.

FIG. 8 illustrates the processing flow of sampling positive and negative meta-paths, in accordance with an example implementation.

FIG. 9 illustrates the positive and negative meta-paths sampled from heterogeneous graph, in accordance with an example implementation.

FIG. 10 illustrates the heterogeneous graph embedding for supply chain in accordance with an example implementation.

FIG. 11 illustrates an example of the path tracing server tracing the physical paths of each product, in accordance with an example implementation.

FIG. 12(A) illustrates an example input of a social network table as the input of heterogeneous graph generation server, in accordance with an example implementation.

FIG. 12(B) illustrates the heterogeneous graph generated, in accordance with an example implementation.

FIG. 13 illustrates the graph generated by heterogeneous graph after fake news detection and clustering, in accordance with an example implementation.

FIG. 14 illustrates the positive meta-paths sample from social network for fake news propagation, in accordance with an example implementation.

FIG. 15 illustrates the negative meta-paths sample from social network for fake news propagation, in accordance with an example implementation.

FIG. 16 illustrates the heterogeneous graph embedding for social network, in accordance with an example implementation.

FIG. 17 illustrates the path tracing server traces the propagation path of fake news, in accordance with an example implementation.

FIG. 18 illustrates a system involving a plurality of systems networked to a management apparatus, in accordance with an example implementation.

FIG. 19 illustrates an example computing environment with an example computer device suitable for use in some example implementations.

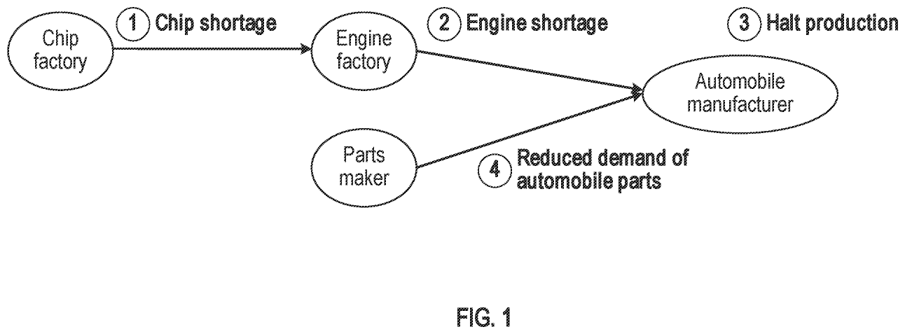

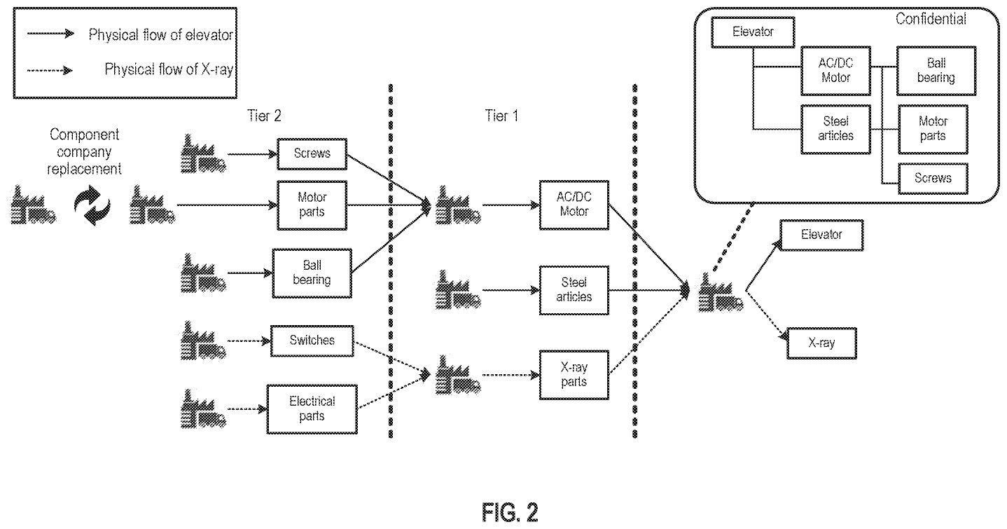

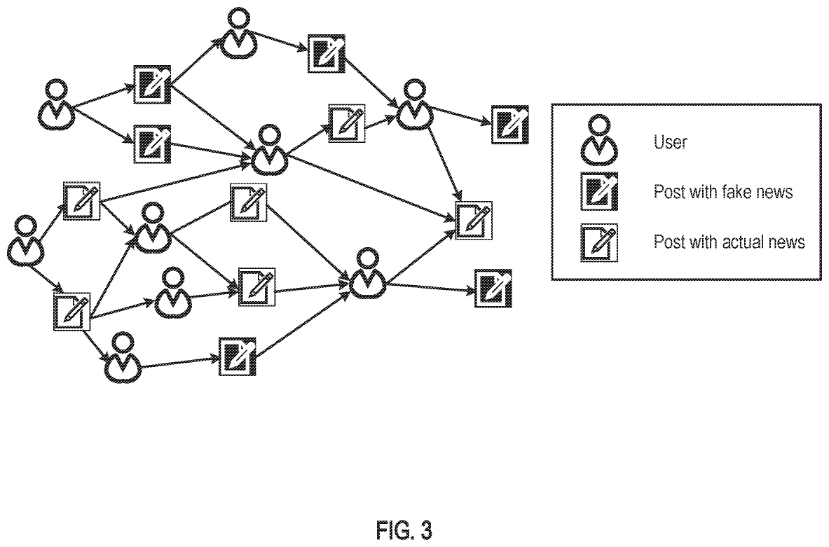

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination, and the functionality of the example implementations can be implemented through any means according to the desired implementations.

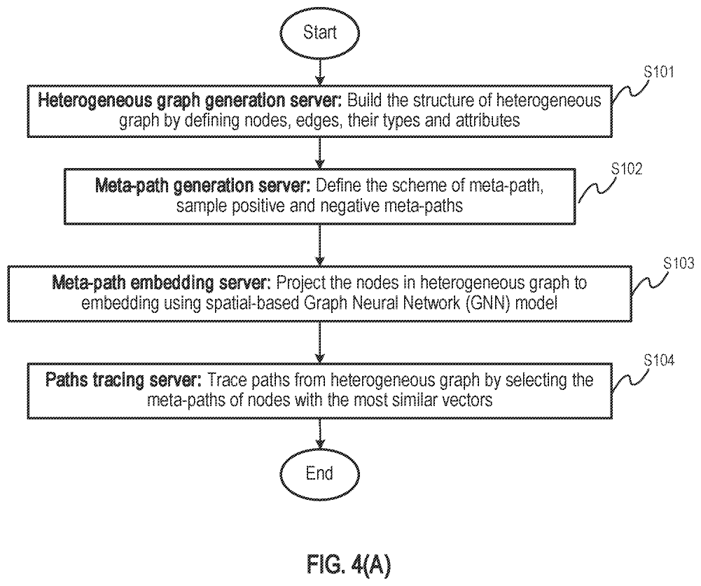

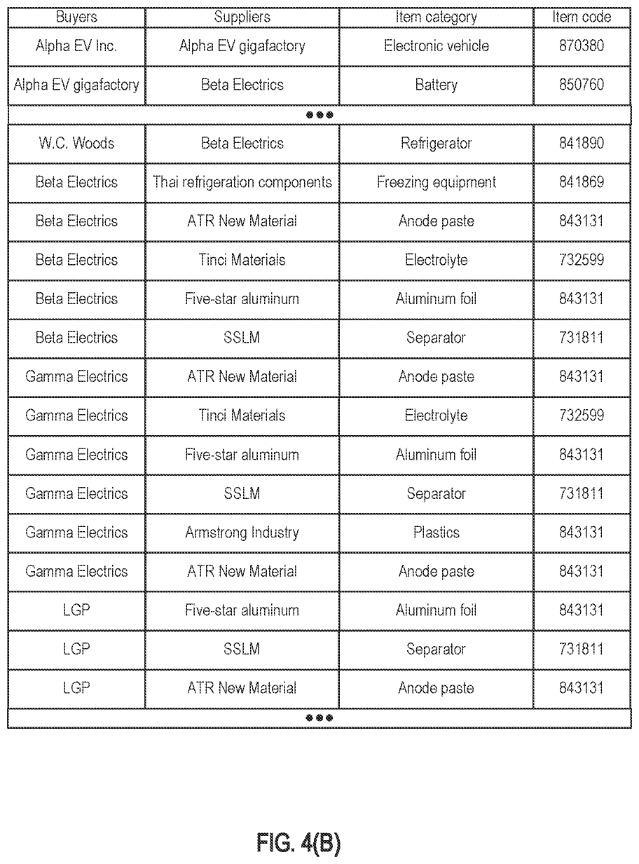

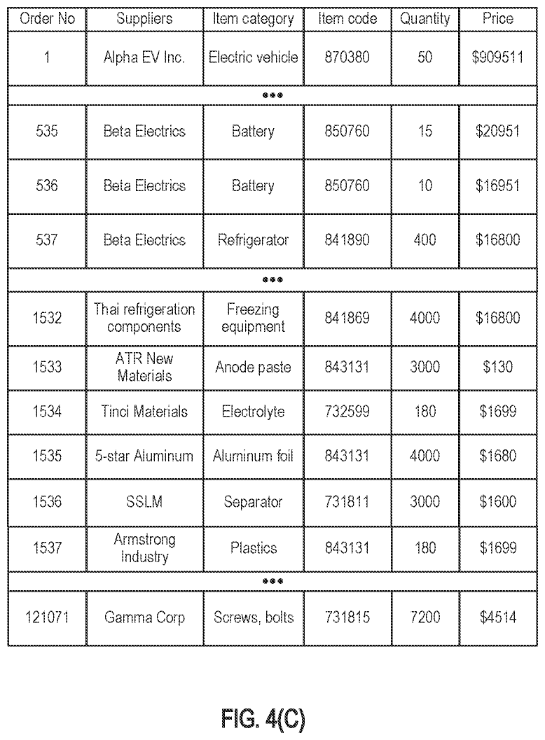

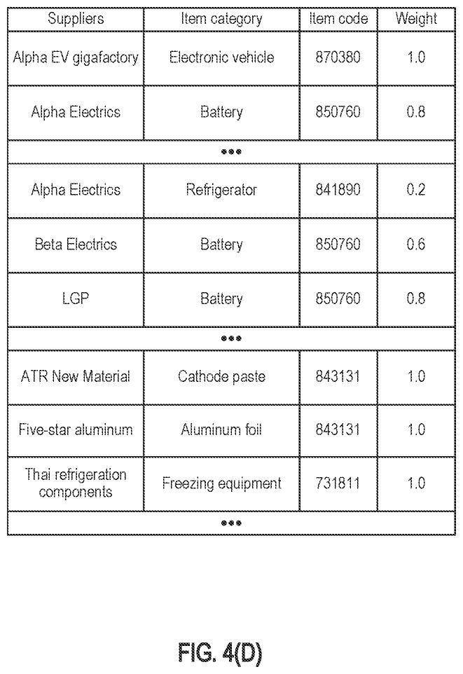

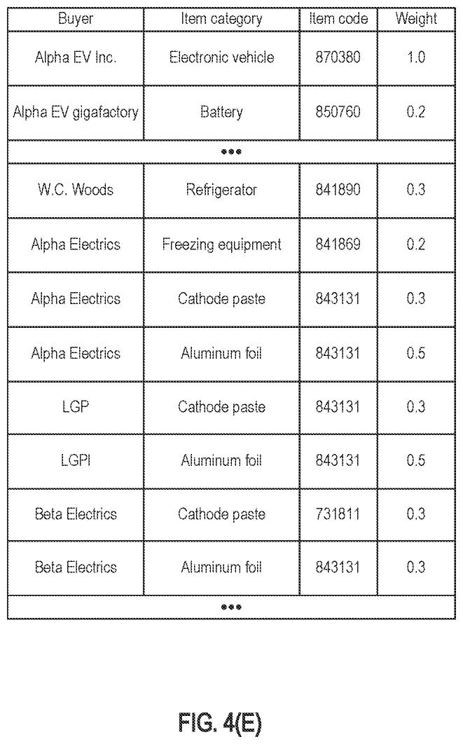

In example implementations described herein, the task of tracing paths in a graph to a graph representation learning task which generates the meta-path embedding of a heterogeneous graph. FIG. 4(A) illustrates the processing flow of paths tracing in heterogeneous graph, in accordance with an example implementation. The processing flow of the example implementations is illustrated in FIG. 4(A), which has four steps.

The first step S101 is building the structure of heterogeneous graph by defining nodes, edges, their types, and attributes in a heterogeneous graph generation server. In graphs such as a supply chain or a social network, there exist a set of objects (nodes) and their relationships (edges). In heterogeneous graphs, the nodes and edges can be multi-type or multi-modal. For instance, the physical flow of the supply chain can be modeled as the relationships between two types of nodes: companies and commodity, and two types of relationships (edges): produce (company—>commodity) and procure (commodity—>company). Similarly, the cashflow of supply chain can be modeled as the relationships between two types of nodes: companies and cash, and two types of relationships (edges): expense (company—>cash) and income (cash—>company). In a social network, there also exist two types of nodes: users, and interactions (e.g., post), and two types of edges: incoming (e.g., read a message) and outgoing interactions (e.g., post a message).

In the heterogeneous graph generation step S101, the nodes are classified or clustered. In a supply chain, products, intermediates, and materials are categorized, by item code or description. For example, the lithium battery is all categorized by a single node, lithium battery, regardless of the underlying supplier. Similarly, for commodities such as anode, cathode, aluminum and other materials, intermediates procured or produced by different company, are also categorized. In social network, posts are also classified. For instance, rumors or fake news can be detected by phrases like “Really”, “Is this true”. The detected rumors or fake news can be further classified by similarity score among statements in posts, such as Jaccard coefficient.

Then, the meta-path is defined as the second step S102. Meta-path is a path scheme which determine the type of nodes and edges in each position of the path. For instance, meta-path of physical flow in supply chain can be defined as:

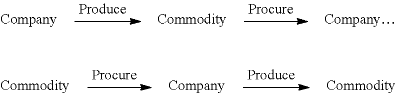

While the meta-path of cashflow in supply chain can be defined as:

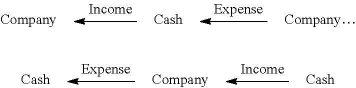

While the meta-path of fake news propagation in social network can be defined as:

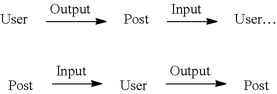

According to the defined meta-path, positive and negative meta-paths are sampled from the heterogeneous graph, by using methods such as random walk with restart. Thus, the positive meta-paths in supply chain are paths from a company supplying raw material, to raw material, to a company that procures raw material and produces parts, to parts, to companies procured parts and produce products to final products. Similarly, positive meta-paths in social network are paths of users post fake news and posts including fake news.

Then the Meta-path embedding server projects the nodes in heterogeneous graph to embedding using models such as spatial-based Graph Neural Network (GNN) at S103. In this step, nodes such as companies, commodities in supply chain, users, posts in social networks are projected to low dimensional vectors considering the topology structure in heterogeneous graph. Thus, vectors of nodes in positive meta-paths are similar than vectors of nodes in negative meta-paths.

Finally, paths tracing server traces paths from heterogeneous graph by selecting the nodes and edges with types defined by meta-paths having the most similar projected vectors at S104.

In a first example implementation, the systems and methods trace physical flow in the supply chain. FIGS. 4(B) and 4(C) illustrate example inputs for the heterogeneous graph generation server, in accordance with an example implementation. Specifically, FIG. 4(13) illustrates an example of the supplier list table as the input of heterogeneous graph generation server. In this example input of a graph structure dataset, node types include company (including supplier and buyer) and commodity (e.g., indicated in item category and item code). Edges can be the procurement or production interaction between company and commodity.

Depending on the desired implementation, products can be categorized based on item code or description. For example, battery companies all produce batteries but have different performance based on the underlying product. Lithium battery can be used as a commodity category, which can be used as a node for the heterogeneous graph.

In an example from FIG. 4(B), buyer Alpha EV Inc. buys commodity from supplier Alpha EV giga-factory. The commodity is electric vehicle with a type according to the item code. Alpha EV giga-factory procures batteries from supplier Beta Electronics, which also has an item code. Batteries can be classified together, and although Beta Electronics also produces refrigerators to another buyer, because refrigerator has a different item code, it will not be classified as the same node as battery.

Further, some materials are also used as input to procure the battery, and the materials (e.g., anode, cathode, aluminum, etc.) can also be grouped by item code for classification.

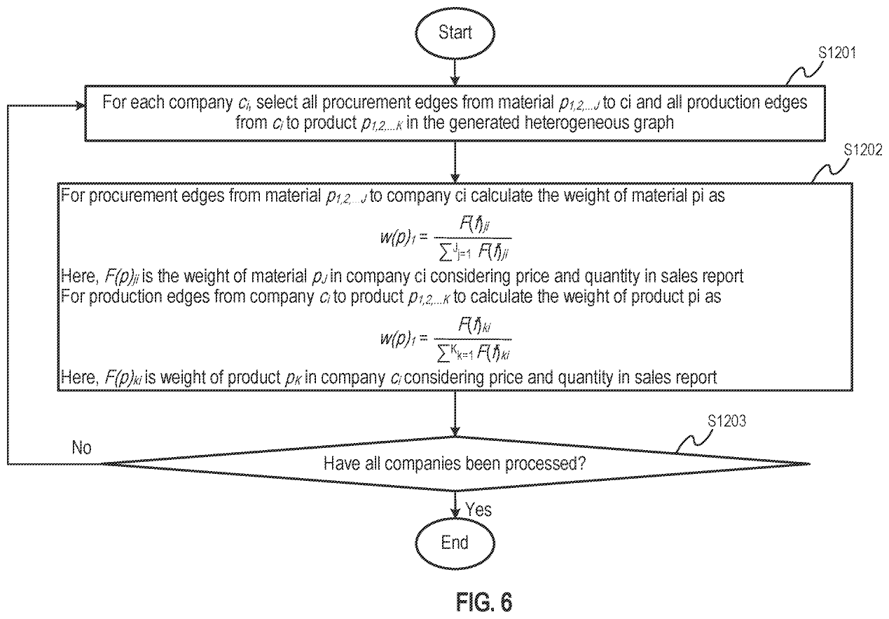

FIG. 4(C) illustrates an example of the sales report table as the input of heterogeneous graph generation server. The sales report table can also be used as an input of the heterogeneous graph generation server to form the weights for the edges as will be described with respect to FIG. 6.

FIGS. 4(D) and 4(E) illustrate example outputs of the heterogeneous graph generation server, in accordance with an example implementation. Specifically, FIG. 4(D) illustrates an example production edge table as the output of heterogeneous graph generation server, which associates supplier with item to be produced along with the weight for the production edge. FIG. 4(E) illustrates an example procurement edge table as the output of heterogeneous graph generation server, which associates buyer with item to be procured along with the corresponding weight.

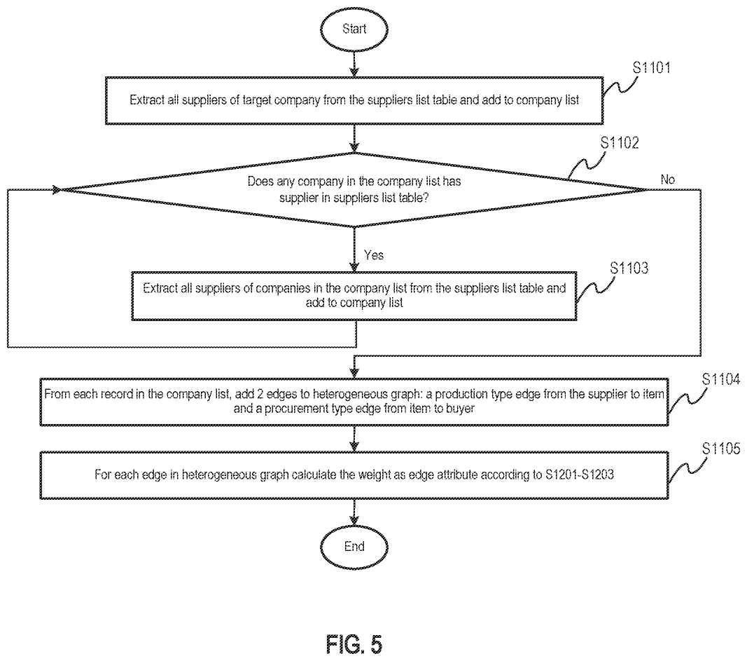

FIG. 5 illustrates the processing flow of heterogeneous graph generation, in accordance with an example implementation. At S1101, the flow starts by extracting all suppliers of the target company from the suppliers list table (FIG. 4(B)) and add the suppliers to the company list. At S1102, the process checks to determine if any company in the company list has a supplier in the suppliers list table. If so (Yes), then the process proceeds to S1103, otherwise (No), the process proceeds to S1104.

At S1103, the process extracts all suppliers of companies in the company list from the suppliers list table and adds it to the company list. Then the flow proceeds back to S1102.

At S1104, the process adds, from each record in the company list, two edges to the heterogeneous graph. The edges involve a production type edge from the supplier to item, and a procurement type edge from item to buyer.

FIG. 6 illustrates an example processing flow of heterogeneous graph attributes generation, in accordance with an example implementation. At S1201, for each company cᵢ, the process select all procurement edges from material p_{1,2 . . . J} to ci and all production edges from cᵢ to product p_{1,2, . . . K} in the generated heterogeneous graph.

At S1202, the edges are weighed. For procurement edges from material p_{1,2 . . . J} to company ci calculate the weight of material pi as

$${w ( p )}_{1} = \frac{{F ( f )}_{ji}}{{\sum }_{j = 1}^{J} {F ( f )}_{ji}}$$

Here, F(p)ⱼᵢ is the weight of material p_{J} in company ci considering price and quantity in sales report from FIG. 4(C).

For production edges from company cᵢ to product p_{1,2 . . . K} to calculate the weight of product pi as

$${w ( p )}_{1} = \frac{{F ( f )}_{ki}}{{\sum }_{k = 1}^{K} {F ( f )}_{ki}}$$

Here, F(p)ₖᵢ is weight of product p_{K} in company cᵢ considering price and quantity in sales report.

At S1203, a determination is made as to whether all of the companies have been processed. If so (Yes), then the process ends, otherwise (No) the process returns to S1201.

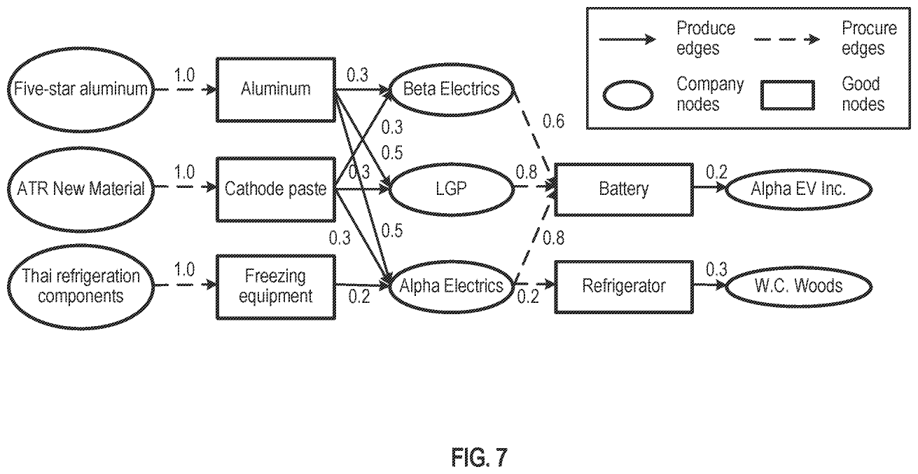

FIG. 7 illustrate a heterogeneous graph of a supply chain, in accordance with an example implementation. Based on the results produced through the flows of FIGS. 5 and 6 using the inputs described in FIGS. 4(B) and 4(C) the heterogenous graph is generated according to the outputs from FIGS. 4(D) and 4(E) with corresponding nodes and edges for display on an interface. The nodes can involve company nodes and good nodes. The edges can involve produce edges and procure edges. Each of the weights indicates the effect the procurement or production to the next node.

Then, the meta-path generation server defines the scheme of the meta-path, and samples positive and negative meta-paths from heterogeneous graph at S104. Meta-path is a path scheme which determines the type of nodes and edges in each position of the path. When tracing the physical flow in supply chain, a meta-path with four nodes and three edges are defined, with types of each node and edges defined as:

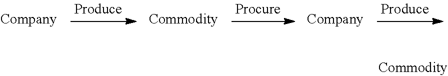

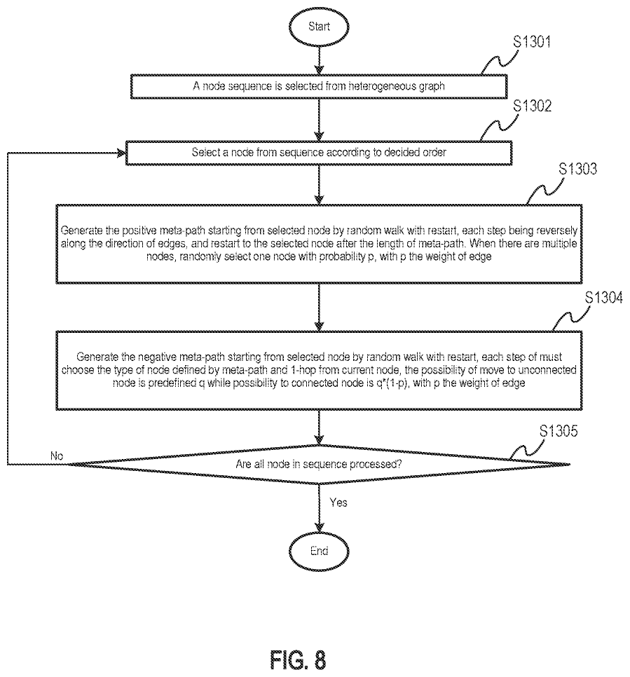

According to the definition, positive meta-paths and negative meta-paths are sampled from heterogeneous graph by random walk with restart using a strategy that considers the weights of the edges. The sampled positive/negative meta-paths will be input to a spatial-based GNN model to learn the embeddings. Specifically, meta-paths are sample sampling according to processing flow illustrated in FIG. 8.

FIG. 8 illustrates the processing flow of sampling positive and negative meta-paths, in accordance with an example implementation. At S1301, a node sequence is selected from a heterogeneous graph, which can be done through a user interface. At S1302, the process selects a node from sequence according to the decided order. At S1303, the process generates the positive meta-paths starting from the selected node by random walk with restart, each step being reversely along the direction of the edges, and restart to the selected node after the length of meta-path. When there are multiple nodes, the process randomly selects one node with probability p, with p being the weight of the edge.

At S1304, the process generates the negative meta-path starting from the selected node by random walk with restart, each step choosing the type of node defined by the meta-path and I-hop from current node, wherein the possibility of move to unconnected node is predefined q while possibility to connected node is q*(1−p), with p being the weight of the edge.

At S1305, a check is made to determine of all the nodes in the sequence are processed. If so (Yes) then the process ends, otherwise (No) the process goes back to S1302.

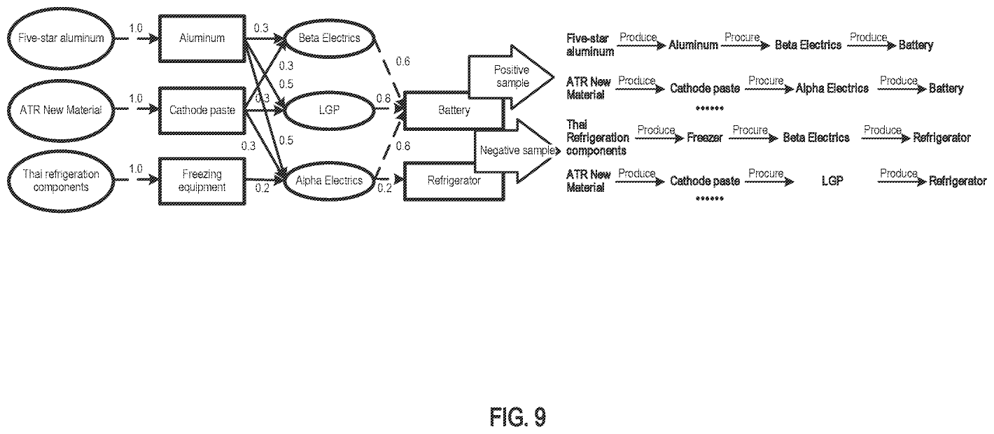

Then, the sample positive and negative meta-paths are learned by models such as the spatial-based GNN model. FIG. 9 illustrates the positive and negative meta-paths sampled from heterogeneous graph, in accordance with an example implementation. Positive meta-paths indicate that the product output requires input from the indicated input through the given path. For example, the output of the good “Battery” has a meta-path from five-star aluminum commodity as an input. Conversely, negative meta-paths indicate that the product output is not affected from the indicated input, so it requires a different input. For example, the output of the good “Refrigerator” is not produced producer Beta Electrics or LGP.

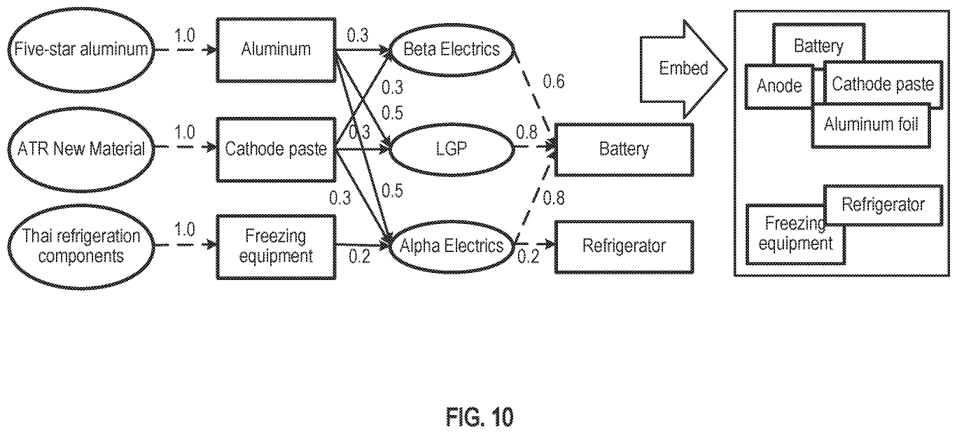

The meta-path aggregated graph neural network can be used to learn the embeddings, as illustrated in FIG. 10. FIG. 10 illustrates the heterogeneous graph embedding for a supply chain, in accordance with an example implementation. As illustrated in the example of FIG. 10, the embeddings for battery involve anode, cathode paste, and aluminum foil, whereas the embedding for refrigerator can involve freezing equipment.

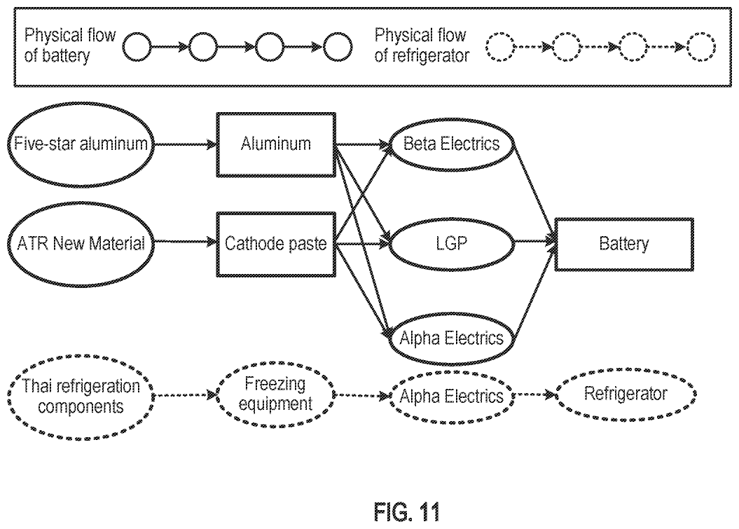

Finally, the path tracing server traces the physical paths of each item (product) by selecting the meta-paths of nodes with the most similar vectors. As a result, the physical flow of battery and refrigerator can be traced as illustrated in FIG. 11.

FIG. 11 illustrates an example of the path tracing server tracing the physical paths of each product, in accordance with an example implementation. As derived from the meta-paths and the embeddings, the physical flow for the battery can be separated from the physical flow for the refrigerator, even if nodes are shared. For example, battery can be determined to be procurable from Beta Electrics, LGP, or Alpha Electrics and is not affected by a supply chain disruption resulting from such suppliers. However, a disruption in production of cathode paste would affect all of the battery suppliers according to the physical flow. Similarly, although cathode paste is supplied to Alpha Electrics, a disruption in cathode paste does not disrupt the capability of Alpha Electrics to produce refrigerators.

In a second example implementation, the systems and methods described herein can be applied for tracing the propagation of fake news in a social network.

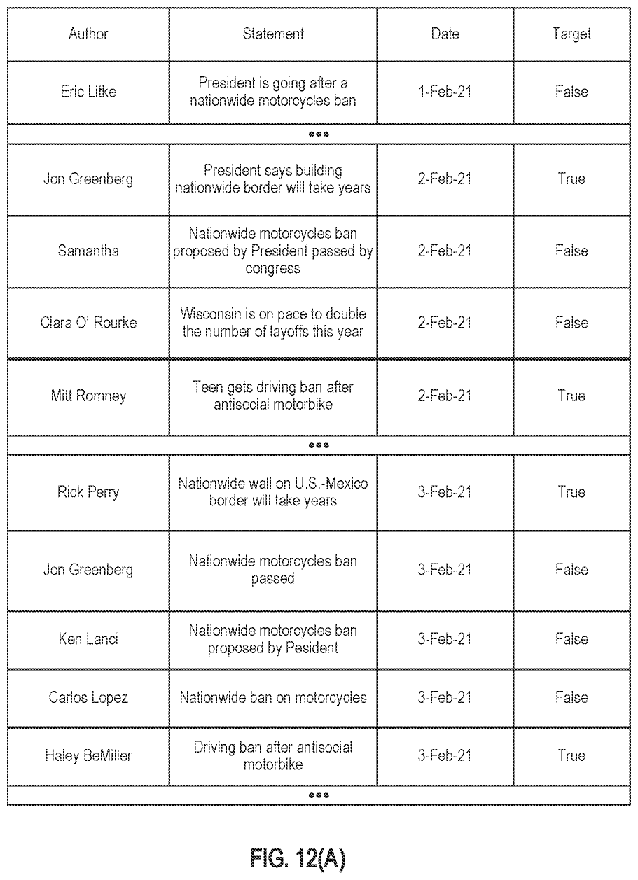

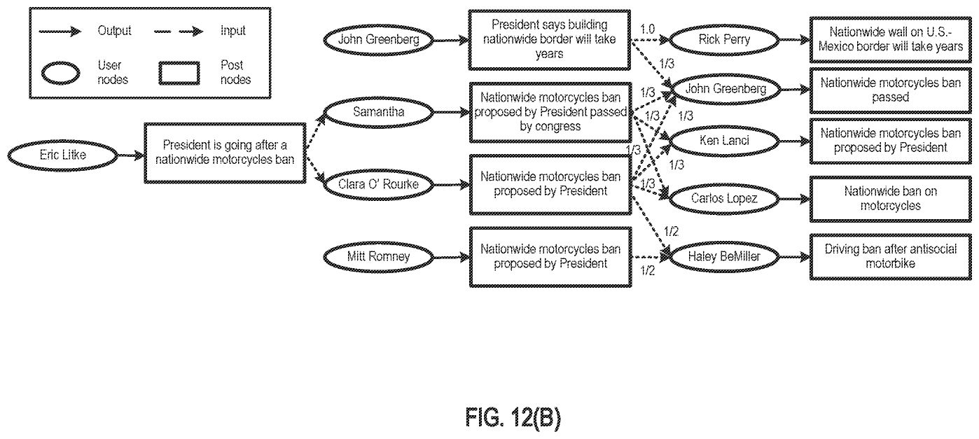

FIG. 12(A) illustrates an example input of a social network table as the input of heterogeneous graph generation server, in accordance with an example implementation. In the example input of a graph structure dataset, the object in this case can be an author and/or a statement, which is associated with a post date and a determination as to whether the social media statement is false or true.

Heterogeneous graph generation server performs Jaccard coefficient or other similarity calculation method to obtain the similarity score among statements. For statements with similarity above the predefined threshold, the example implementations create an input edge from the earlier statement to user posts having a similar statement later. The result is illustrated in FIG. 12(B). FIG. 12(B) illustrates the heterogeneous graph generated, in accordance with an example implementation. Using the same techniques as described herein, the nodes can involve the user node or post node, and the edges can denote output (i.e., post is provided to another user) or input (post is displayed to the user).

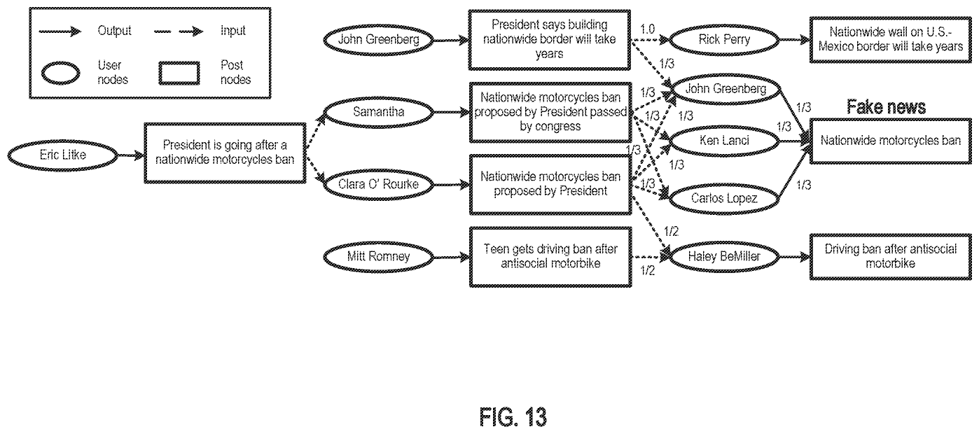

Then, the fake news detection and clustering are performed. Meanwhile, for each user, the weight of each input edge is calculated as 1/n, n is the number of input edges to the user, resulting in FIG. 13. FIG. 13 illustrates the graph generated by heterogeneous graph after fake news detection and clustering, in accordance with an example implementation.

The meta-path of fake news propagation in social network can be defined as:

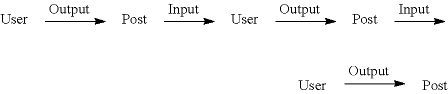

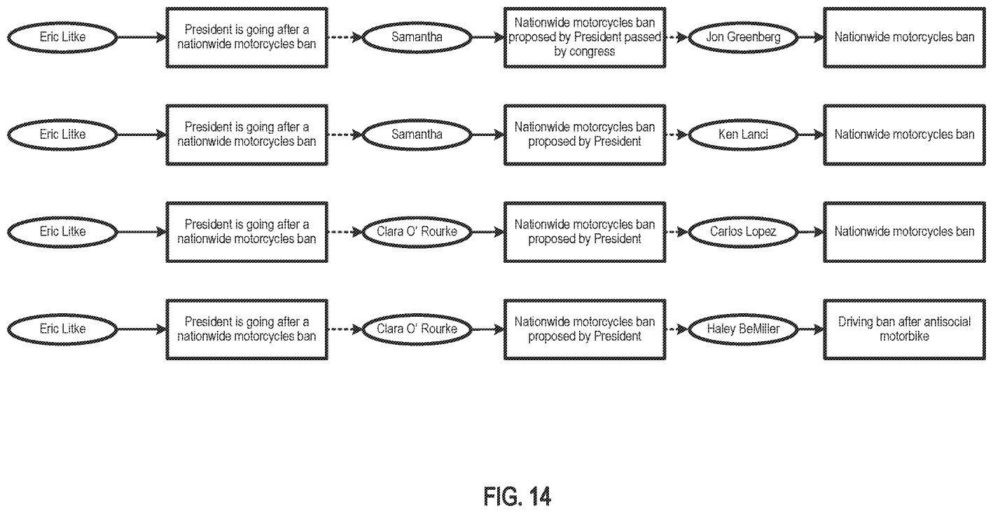

Accordingly, the positive and negative meta-paths are sampled. Through using the example implementations as described above, the meta-paths can be similarly determined, as well as the graph embedding and path tracing as illustrated in FIGS. 14 to 17.

FIG. 14 illustrates the positive meta-paths sample from social network for fake news propagation, in accordance with an example implementation.

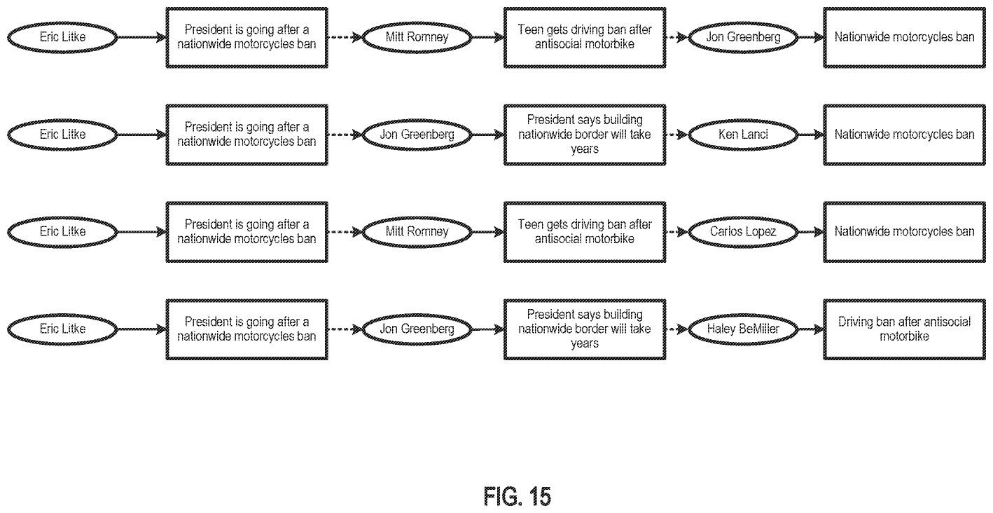

FIG. 15 illustrates the negative meta-paths sample from social network for fake news propagation, in accordance with an example implementation.

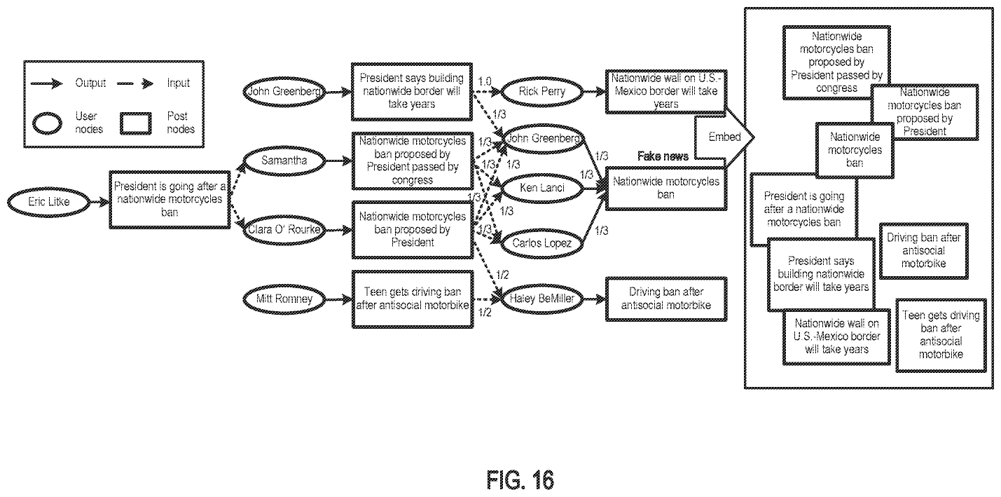

FIG. 16 illustrates the heterogeneous graph embedding for social network, in accordance with an example implementation.

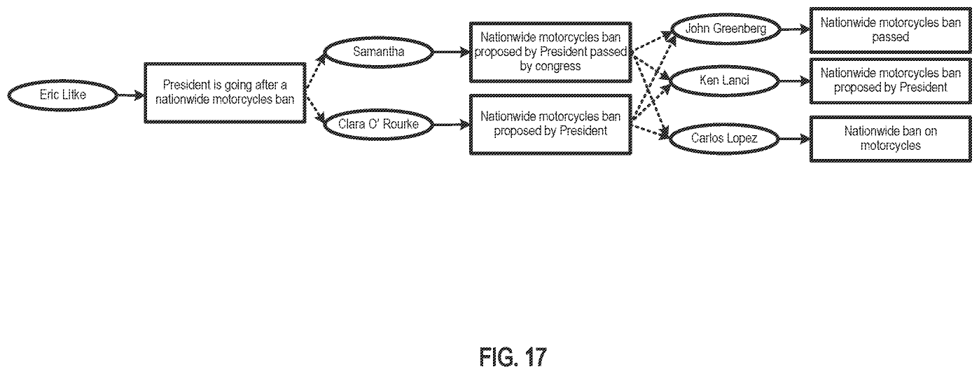

FIG. 17 illustrates the path tracing server traces the propagation path of fake news, in accordance with an example implementation.

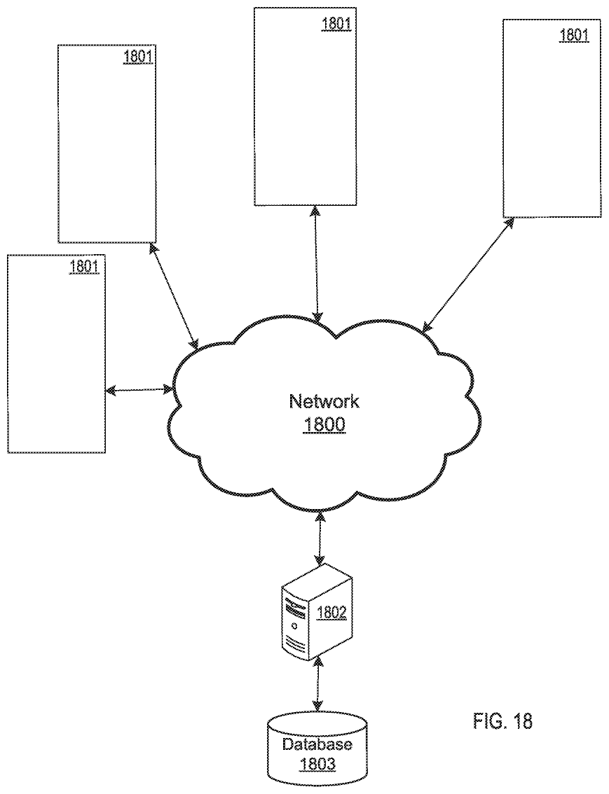

FIG. 18 illustrates a system involving a plurality of systems networked to a management apparatus, in accordance with an example implementation. One or more systems 1801 are communicatively coupled to a network 1800 (e.g., local area network (LAN), wide area network (WAN)) through the corresponding server, which is connected to a management apparatus 1802. The management apparatus 1802 manages a database 1803, which contains historical data collected from the other systems 1801, In alternate example implementations, the data can be stored to a central repository or central database such as proprietary databases that intake data from the systems, or systems such as enterprise resource planning systems, and the management apparatus 1802 can access or retrieve the data from the central repository or central database.

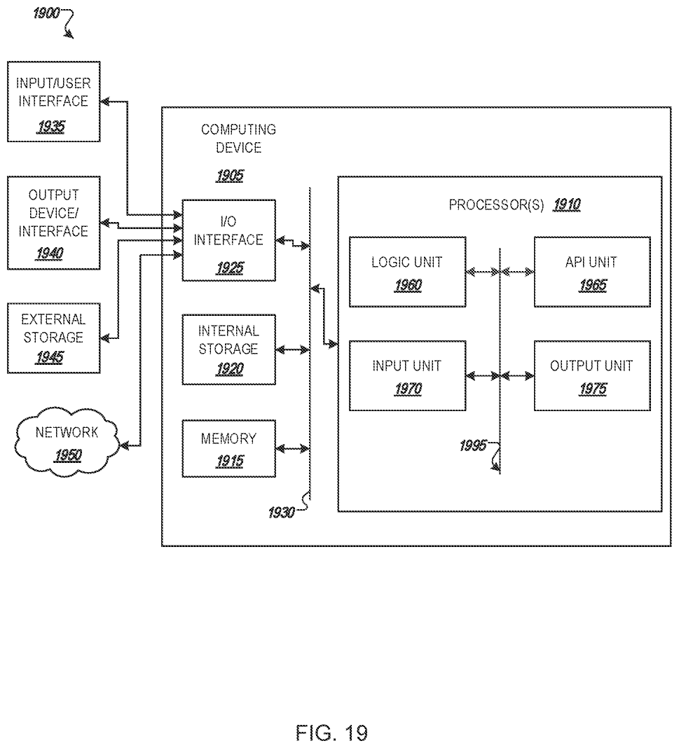

FIG. 19 illustrates an example computing environment with an example computer device suitable for use in some example implementations, such as a management apparatus 1802 as illustrated in FIG. 18. Computer device 1905 in computing environment 1900 can include one or more processing units, cores, or processors 1910, memory 1915 (e.g., RAM, ROM, and/or the like), internal storage 1920 (e.g., magnetic, optical, solid state storage, and/or organic), and/or I/O interface 1925, any of which can be coupled on a communication mechanism or bus 1930 for communicating information or embedded in the computer device 1905. I/O interface 1925 is also configured to receive images from cameras or provide images to projectors or displays, depending on the desired implementation.

Computer device 1905 can be communicatively coupled to input/user interface 1935 and output device/interface 1940. Either one or both of input/user interface 1935 and output device/interface 1940 can be a wired or wireless interface and can be detachable. Input/user interface 1935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1940 may include a display, television, monitor, printer, speaker, braille, or the like. In some example implementations, input/user interface 1935 and output device/interface 1940 can be embedded with or physically coupled to the computer device 1905. In other example implementations, other computer devices may function as or provide the functions of input/user interface 1935 and output device/interface 1940 for a computer device 1905.

Examples of computer device 1905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1905 can be communicatively coupled (e.g., via I/O interface 1925) to external storage 1945 and network 1950 for communicating with any number of networked components, devices, and systems, including one or more computer devices of the same or different configuration. Computer device 1905 or any connected computer device can be functioning as, providing services of, or referred to as a server, client, thin server, general machine, special-purpose machine, or another label.

I/O interface 1925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1900. Network 1950 can be any network or combination of networks (e.g., the Internet, local area network, wide area network, a telephonic network, a cellular network, satellite network, and the like).

Computer device 1905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1910 can execute under any operating system (OS) (not shown), in a native or virtual environment. One or more applications can be deployed that include logic unit 1960, application programming interface (API) unit 1965, input unit 1970, output unit 1975, and inter-unit communication mechanism 1995 for the different units to communicate with each other, with the OS, and with other applications (not shown). The described units and elements can be varied in design, function, configuration, or implementation and are not limited to the descriptions provided. Processor(s) 1910 can be in the form of hardware processors such as central processing units (CPUs) or in a combination of hardware and software units.

In some example implementations, when information or an execution instruction is received by API unit 1965, it may be communicated to one or more other units (e.g., logic unit 1960, input unit 1970, output unit 1975). In some instances, logic unit 1960 may be configured to control the information flow among the units and direct the services provided by API unit 1965, input unit 1970, output unit 1975, in some example implementations described above. For example, the flow of one or more processes or implementations may be controlled by logic unit 1960 alone or in conjunction with API unit 1965. The input unit 1970 may be configured to obtain input for the calculations described in the example implementations, and the output unit 1975 may be configured to provide output based on the calculations described in example implementations.

Processor(s) 1910 can be configured to execute a method or instructions to trace flow of a node in a graph structure dataset through meta-paths, which can involve, for an input of a graph structure dataset having a plurality of nodes and a plurality of edges, each of the plurality of nodes representative of an object, each of the plurality of edges representative of an interaction between each of the plurality of nodes (e.g., produce, procure, post, read, etc. as illustrated in FIGS. 4(B), 4(C), and 12(A)): defining types (e.g., user node, post node, company node, commodity node) and attributes (e.g., target, item code, item category, statement, user name, etc.) for the plurality of nodes and the plurality of edges to generate a heterogenous graph from the input graph structure dataset; associating the plurality of nodes with each other based on similarity (e.g., based on classification or by clustering); defining a scheme for a meta-path between the plurality of nodes and the plurality of edges based on defined flows (e.g., physical flow, social media flow, etc.); sampling positive meta-paths and negative meta-paths for a selected node from the heterogenous graph based on the defined scheme, the associated plurality of nodes and the defined types and attributes for the associated plurality of nodes (e.g., tracing physical flow; tracing specific fake news, predefined probability of a node not being connected with a current node) projecting the associated plurality of nodes into embedded vectors (e.g., from path to vector such as GNN); tracing the sampled positive meta-paths and negative meta-paths from the heterogenous graph by selecting ones of the sampled positive meta-paths and the negative meta-paths of the associated nodes having a similarity greater than a preset threshold; and outputting the selected ones of the sampled positive meta-paths and the negative meta-paths through an interface as illustrated in FIGS. 11 and 17.

Processor(s) 1910 can be configured to execute a method or instructions as described above, wherein each of the plurality of nodes is associated with a company, wherein each of the plurality of edges is representative of a procurement or production interaction between the company and a commodity (e.g., such as goods) as illustrated in FIG. 7 to 11.

Processor(s) 1910 can be configured to execute the method or instructions as described above, and further involve monitoring the plurality of edges associated with the selected node.

Processor(s) 1910 can be configured to execute the method or instructions as described above, wherein the associating the plurality of nodes with each other based on similarity involves classifying the plurality of nodes based on the types and attributes of the physical flow of input or output goods and determining a similarity score from the classifying as illustrated in FIG. 6.

Processor(s) 1910 can be configured to execute the method or instructions as described above, wherein each of the plurality of nodes is representative of a social media user and post, wherein each of the plurality of edges is representative of an input post to be read or an output post on a social media platform as illustrated in FIGS. 12(A) to 17.

Processor(s) 1910 can be configured to execute the method or instructions as described above, wherein the associating the plurality of nodes with each other based on similarity involves classifying the social media post as real news or fake news based on similarity of the types and attributes of the social media account and social media post to real news or fake news, and clustering the plurality of nodes and the plurality of edges based on the similarity of the types and attributes to determine weights for the plurality of edges.

Processor(s) 1910 can be configured to execute the method or instructions as described above, wherein the projecting the associated plurality of nodes into embedded vectors involves inputting the sampled positive meta-paths and negative meta-paths to a spatial based graph neural network as described with respect to S103.

Processor(s) 1910 can be configured to execute the method or instructions as described above, wherein the positive meta-paths are representative of possible paths from the selected node to another one of the plurality of nodes, wherein the negative meta-paths are representative of ones of the plurality of nodes that are not reachable by the selected node as illustrated in FIG. 9.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method to trace flow of a node in a graph structure dataset through meta-paths, comprising:
for an input of a graph structure dataset comprising a plurality of nodes and a plurality of edges, each of the plurality of nodes representative of an object, each of the plurality of edges representative of an interaction between each of the plurality of nodes:
defining types and attributes for the plurality of nodes and the plurality of edges to generate a heterogenous graph from the input graph structure dataset;
associating the plurality of nodes with each other based on similarity;
defining a scheme for a meta-path between the plurality of nodes and the plurality of edges based on defined flows;
sampling positive meta-paths and negative meta-paths for a selected node from the heterogenous graph based on the defined scheme, the associated plurality of nodes and the defined types and attributes for the associated plurality of nodes;
projecting the associated plurality of nodes into embedded vectors;
tracing the sampled positive meta-paths and negative meta-paths from the heterogenous graph by selecting ones of the sampled positive meta-paths and the negative meta-paths of the associated nodes having a similarity greater than a preset threshold; and
outputting the selected ones of the sampled positive meta-paths and the negative meta-paths through an interface.

2. The method of claim 1, wherein each of the plurality of nodes is associated with a company, wherein each of the plurality of edges is representative of a procurement or production interaction between the company and a commodity.

3. The method of claim 2, further comprising monitoring the plurality of edges associated with the selected node.

4. The method of claim 2, wherein the associating the plurality of nodes with each other based on similarity comprises classifying the plurality of nodes based on the types and attributes of the physical flow of input or output goods and determining a similarity score from the classifying.

5. The method of claim 1, wherein each of the plurality of nodes is representative of a social media user and post, wherein each of the plurality of edges is representative of an input post to be read or an output post on a social media platform.

6. The method of claim 5, wherein the associating the plurality of nodes with each other based on similarity comprises classifying the social media post as real news or fake news based on similarity of the types and attributes of the social media account and social media post to real news or fake news, and clustering the plurality of nodes and the plurality of edges based on the similarity of the types and attributes to determine weights for the plurality of edges.

7. The method of claim 1, wherein the projecting the associated plurality of nodes into embedded vectors comprises inputting the sampled positive meta-paths and negative meta-paths to a spatial based graph neural network.

8. The method of claim 1, wherein the positive meta-paths are representative of possible paths from the selected node to another one of the plurality of nodes, wherein the negative meta-paths are representative of ones of the plurality of nodes that are not reachable by the selected node.

9. A non-transitory computer readable medium, storing instructions to trace flow of a node in
a graph structure dataset through meta-paths, the instructions comprising:
for an input of a graph structure dataset comprising a plurality of nodes and a plurality of edges, each of the plurality of nodes representative of an object, each of the plurality of edges representative of an interaction between each of the plurality of nodes:
defining types and attributes for the plurality of nodes and the plurality of edges to generate a heterogenous graph from the input graph structure dataset;
associating the plurality of nodes with each other based on similarity;
defining a scheme for a meta-path between the plurality of nodes and the plurality of edges based on defined flows;
sampling positive meta-paths and negative meta-paths for a selected node from the heterogenous graph based on the defined scheme, the associated plurality of nodes and the defined types and attributes for the associated plurality of nodes;
projecting the associated plurality of nodes into embedded vectors;
tracing the sampled positive meta-paths and negative meta-paths from the heterogenous graph by selecting ones of the sampled positive meta-paths and the negative meta-paths of the associated nodes having a similarity greater than a preset threshold; and
outputting the selected ones of the sampled positive meta-paths and the negative meta-paths through an interface.

10. The non-transitory computer readable medium of claim 9, wherein each of the plurality of nodes is associated with a company, wherein each of the plurality of edges is representative of a procurement or production interaction between the company and a commodity.

11. The non-transitory computer readable medium of claim 10, the instructions further comprising monitoring the plurality of edges associated with the selected node.

12. The non-transitory computer readable medium of claim 10, wherein the associating the plurality of nodes with each other based on similarity comprises classifying the plurality of nodes based on the types and attributes of the physical flow of input or output goods and determining a similarity score from the classifying.

13. The non-transitory computer readable medium of claim 9, wherein each of the plurality of nodes is representative of a social media user and post, wherein each of the plurality of edges is representative of an input post to be read or an output post on a social media platform.

14. The non-transitory computer readable medium of claim 13, wherein the associating the plurality of nodes with each other based on similarity comprises classifying the social media post as real news or fake news based on similarity of the types and attributes of the social media account and social media post to real news or fake news, and clustering the plurality of nodes and the plurality of edges based on the similarity of the types and attributes to determine weights for the plurality of edges.

15. The non-transitory computer readable medium of claim 9, wherein the projecting the associated plurality of nodes into embedded vectors comprises inputting the sampled positive meta-paths and negative meta-paths to a spatial based graph neural network.

16. The non-transitory computer readable medium of claim 9, wherein the positive meta-paths are representative of possible paths from the selected node to another one of the plurality of nodes, wherein the negative meta-paths are representative of ones of the plurality of nodes that are not reachable by the selected node.

17. An apparatus configured to trace flow of a node in a graph structure dataset through meta-paths, the apparatus comprising:
a processor, configured to:
for an input of a graph structure dataset comprising a plurality of nodes and a plurality of edges, each of the plurality of nodes representative of an object, each of the plurality of edges representative of an interaction between each of the plurality of nodes:
define types and attributes for the plurality of nodes and the plurality of edges to generate a heterogenous graph from the input graph structure dataset;
associating the plurality of nodes with each other based on similarity;
define a scheme for a meta-path between the plurality of nodes and the plurality of edges based on defined flows;
sample positive meta-paths and negative meta-paths for a selected node from the heterogenous graph based on the defined scheme, the associated plurality of nodes and the defined types and attributes for the associated plurality of nodes;
project the associated plurality of nodes into embedded vectors;
trace the sampled positive meta-paths and negative meta-paths from the heterogenous graph by selecting ones of the sampled positive meta-paths and the negative meta-paths of the associated nodes having a similarity greater than a preset threshold; and
output the selected ones of the sampled positive meta-paths and the negative meta-paths through an interface.
